(19) United States
(12) Patent Application Publication
(10) Pub. No.: US 2006/0109482 A1
(43) Pub. Date: May 25, 2006

(54) 3D and 2D measurement system and method with increased sensitivity and dynamic range

(76) Inventors: Yan Duval, Beaconsfield (CA); Benoit Quirion, Boucherville (CA); Mathieu Lamarre, Verdun (CA); Michel Cantin, Brossard (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/295,493

(22) Filed: Dec. 7, 2005

Related U.S. Application Data
(63) Continuation of application No. PCT/CA04/00832, filed on Jun. 9, 2004.

(51) Int. Cl. G01B 11/30

(52) U.S. Cl. 356/605

(57) ABSTRACT

The present invention provides a Fast Moiré Interferometry (FMI) method and system for measuring the height profile of an object with an increase precision by combining a plurality of image features. In one large aspect of the invention, two or several images are acquired under different conditions, to yield two or several images: Iₐ′(x,y), Iₐ″(x,y), . . . instead of one single image Iₐ(x,y). This is repeated for images obtained with different grating projection “b”, “c”, and “d”. These images are combined to provide combined images or a merged phase value, which are used to determine the object height profile.

### CROSS-REFERENCE TO RELATED APPLICATIONS

This application is a continuation of PCT Serial Number PCT/CA2004/000832 filed Jun. 9, 2004 which claims priority from U.S. Ser. No. 60/477,324.

### FIELD OF THE INVENTION

The present invention relates to measurement systems and methods. More specifically, the present invention is concerned with a 3D and 2D measurement system and a method based on Fast Moiré Interferometry (FMI) with increased sensitivity and dynamic range.

### BACKGROUND OF THE INVENTION

In automated 3D and 2D vision inspection systems, measurements are usually based on an image analysis and a processing of retrieved information. The image acquisition generally includes a step of data digitalization. For example, a digital 8 bits CCD camera (charged coupled device video camera) quantifies a signal according to a linear scale of 255 gray levels, whereby dark regions have low-level intensities, while light spots can yield saturation, with intensity value that may reach 255 on the gray scale and corresponding to even higher real values. The well known Fast Moiré interferometry method (FMI) is a phase-shift method based on a combination of structured light projection and phase-shift method for 3D and 2D information extraction at each point of an image. The FIG. 1 presents an example of an FMI system. The FMI method uses the acquisition and analysis of several images with different grating projection. The 3D information extraction is based on an evaluation of intensity variation of each point with structured light modification.

The application of the FMI method to different surfaces with different reflectivity is well known. The method allows inspection of objects that may comprise both dark and very bright regions. As a result, the FMI method is used for example, for inspection of microelectronic components such as BGA (for “ball grid array”) or CSP (“chip scale package”). Such microelectronic components comprise connectors having different shapes (and reflectances), in such a way that areas of the components thereof, corresponding to an angle of specular reflectivity, are very bright, while other areas are rather dark.

Basically, the FMI method analyzes a point intensity variation with projected grating modification. However, in the case of the presence of saturated points and dark points in a same image, the method is limited in sensitivity and dynamic range, since the information that can be obtained is limited to a restricted number of points, excluding dark and saturated points.

Therefore, there is a need for a system and a method allowing enhancing a quality, sensibility, and dynamic range of 3D and 2D measurement.

### OBJECTS OF THE INVENTION

An object of the present invention is therefore to provide an improved 3D and 2D measurement system and method.

Other objects, advantages and features of the present invention will become more apparent upon reading of the following non restrictive description of embodiments thereof, given by way of example only with reference to the accompanying drawings.

### SUMMARY OF THE INVENTION

More specially, in accordance with the present invention, there is provided a Fast Moiré Interferometry (FMI) method and system for measuring the height profile of an object with an increase precision by combining a plurality of image features.

The interferometry method for determining a height profile of an object comprises obtaining, at a first acquiring condition, at least two image features characterizing the object, each one of the image features being obtained at different gathering conditions, so as to provide a first set of at least two image features; obtaining, at a second acquiring condition, at least one image feature characterizing the object so as to provide a second set of at least one image feature. The method also comprises merging the image features for providing a merged image feature; and determining the height profile using the merged image feature and a phase value associated to a reference surface. The method further comprises evaluating the volume of the object.

In accordance with one large aspect of the invention, an interferometric method is provided for determining a height profile of an object. The method comprises obtaining a first set of at least two intensities characterizing the object at a first projection of an intensity pattern on the object, each one of the intensities corresponding to a different gathering condition, and combining the intensities to obtain a first merged image; obtaining a second set of at least one intensity characterizing the object at a phase-shifted projection of the intensity pattern on the object and combining the intensities of the second set to obtain a second merged image. The method also comprises determining the height profile using the first and second merged images and a phase value associated to a reference surface.

In accordance with another large aspect of the invention, an interferometric method for determining a height profile of an object is provided, the method comprising obtaining a first set of intensities characterizing the object under a first acquiring condition, each of the intensities characterizing the object corresponding to one of a series of projecting intensities on the object, each of the projecting intensities being phase-shifted from the other, and calculating a first phase value using the first set on intensities. The method also comprises obtaining a second set of intensities characterizing the object under a second acquiring condition, each of the intensities of the second set corresponding to one of a second series of projecting intensities on the object, each of the projecting intensities of the second series being phase-shifted from the others, and calculating a second phase value using the second set on intensities. The method also comprises merging the phase values for providing a merged phase value, and determining the height profile using the merged phase value and a phase value associated to a reference surface.

In accordance with another large aspect of the invention, several intensities characterizing the object are acquired under different conditions and are either combined, to obtain a set of combined images from which a phase value characterizing the object is calculated, or are used to calculate a set of phase values that are merged to a merged phase characterizing the object.

In accordance with another large aspect of the invention, an interferometric system for determining a height profile of an object is provided. The system comprises a pattern projection assembly for projecting, onto the object, an intensity pattern along a projection axis, and displacement means for positioning, at selected positions, the intensity pattern relative to the object. The system also comprises a detection assembly for obtaining, at a first acquiring condition, a first set of at least two image features, and obtaining, at a second acquiring condition, a second set of at least one image feature; and a computer for calculating a merged feature using the images features and for determining the height profile of the object by using the merged feature and a reference phase value associated to the reference surface. The interferometric system further has at least one following characteristics: the detection assembly has a tunable acquisition time and the pattern projection assembly has a tunable intensity projection.

### BRIEF DESCRIPTION OF THE DRAWINGS

In the appended drawings:

FIG. 1, which is labeled “PRIOR ART”, is a schematic view of a FMI system as used in the art;

FIG. 2 is a flowchart of a method for determining the height profile of an object according to an embodiment of the present invention;

FIG. 3 is a flowchart of part of the method of FIG. 2 according to an embodiment of the present invention;

FIG. 4 is a flowchart of part of the method of FIG. 2 according to another embodiment of the present invention;

FIG. 5 is a schematic view of the system for determining the height profile of an object according to an embodiment of the present invention;

FIG. 6 is a block diagram describing the relations between the system components and a controller according to an embodiment of the present invention.

### DESCRIPTION OF EMBODIMENTS OF THE INVENTION

Generally stated, the present invention provides a system and a method allowing an increased sensitivity and dynamic range of phase-shift measurement methods.

The present invention will be described in relation to an example of four phase-shifted images, but may be applied to any system of three or more phase-shifted images. Also, under certain conditions, the present invention may be applied to a group of only two images.

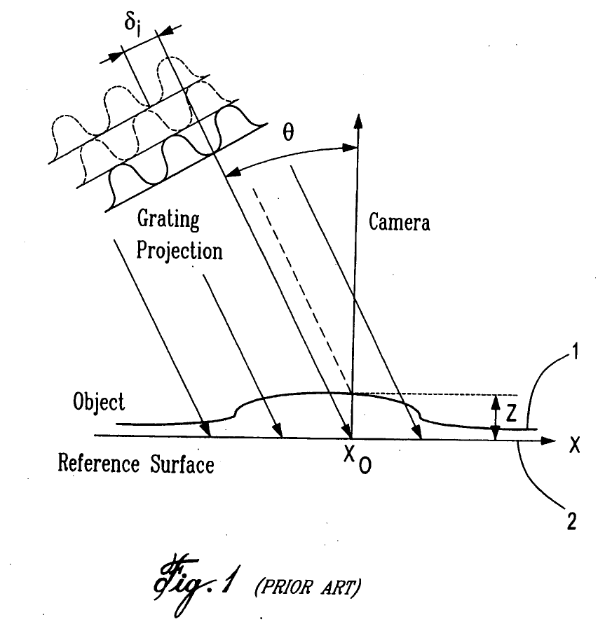

In the FMI method, the 3D analysis is based on the variation of a grid projected on an inspected object. Referring to FIG. 1, an intensity pattern is projected on the object at a first position and a first light intensity characterizing the object (also called an image) is measured with the camera. Then the intensity pattern is shifted from its previous position (the so-called phase-shit) and another image is measured.

In the particular case where four phase-shifted images are acquired, the following system of equations is used:

$$\{ \begin{matrix}{I}_{a} ( x , y ) = R ( x , y ) \cdot [ 1 + M ( x , y ) \cdot Cos ( φ ( x , y ) ) ] \\ {I}_{b} ( x , y ) = R ( x , y ) \cdot [ 1 + M ( x , y ) \cdot Cos ( φ ( x , y ) + π / 2 ) ] \\ {I}_{c} ( x , y ) = R ( x , y ) \cdot [ 1 + M ( x , y ) \cdot Cos ( φ ( x , y ) + π ) ] \\ {I}_{d} ( x , y ) = R ( x , y ) \cdot [ 1 + M ( x , y ) \cdot Cos ( φ ( x , y ) + 3 π / 2 ) ]\end{matrix} \qquad ( 1 )$$

where I(x,y) is the light intensity at the object coordinates (x,y), R(x,y) is proportional to the object reflectance and lighting source intensity, and M(x,y) is a fringe pattern modulation (also called the pattern contrast).

By resolving this system of equations (1), the phase φ(x,y) can be founded as follow:

$$tg φ ( x , y ) = \frac{{I}_{d} ( x , y ) - {I}_{b} ( x , y )}{{I}_{a} ( x , y ) - {I}_{c} ( x , y )} \qquad ( 2 )$$

This phase value is linked to object height information. It can be shown that the phase value is indeed a function of the height z(x,y) of the object. It is thus possible to determine the height z(x,y) of the object with respect to a reference surface by knowing the intensity pattern characteristics and the phase value associated to the reference surface.

In order to be able to correctly calculate the phase value according to above the relation (2), all four intensity values Iₐ(x,y), I_{b}(x,y), I_{c}(x,y), and I_{d}(x,y) must be “valid”. A valid value would be a value that is believed to be good, an invalid value would be one that is suspected to be false. For example, an invalid value can be an intensity value from a particular object portion that is saturating the camera pixel and therefore the real value is not measured. At the opposite, an intensity that is well below the noise level of the detection system will be registered falsely as an higher intensity.

Should one or several of the four intensities values I(x,y) be saturated relation (2) yields an error in the phase calculation. Similarly, should all four intensities Iₐ(x,y), I_{b}(x,y), I_{c}(x,y), I_{d}(x,y) be close together (at the noise level), the phase evaluated by means of relation (2) is highly unprecise. Thus invalid data would lead to false values of height measurement of the object.

The present invention therefore provides a system and a method to increase sensitivity and dynamic range of the FMI technique described hereinabove.

Combined Images, Ĩ(x,y):

In one large aspect of the invention, combined images of the object are formed by merging images of the object. In a nutshell, during image acquisition, two or several images (also referred to as intensities characterizing the object) are acquired with different sensitivities (for example by acquiring images with different exposing times) or with different light source intensities, to yield two or several images: Iₐ′(x,y), Iₐ″(x,y), . . . instead of one single image Iₐ(x,y). This is repeated for images obtained with different grating projection “b”, “c”, and “d”. For example, the intensity I′(x,y) is acquired with more sensitivity (greater exposing time) than those indexed as I″(x,y) or with different light source intensities.

It is possible to obtain an effective combined image Ĩₐ(x,y) as a combination of images Iₐ′(x,y), Iₐ″(x,y), . . . . For example, in an 8 bits acquisition system, a new 16 bits image Ĩₐ(x,y) can be formed taking into account a composition of Iₐ′(x,y) for upper and Iₐ″(x,y) for lower significant bits, and the final phase value is calculated using the combined effective images associated to each grating projection as follows:

$$tg φ = \frac{{\tilde{I}}_{d} ( x , y ) - {\tilde{I}}_{b} ( x , y )}{{\tilde{I}}_{a} ( x , y ) - {\tilde{I}}_{c} ( x , y )} \qquad ( 3 )$$

Combined Phase Values \tilde{φ}(x,y):

It is also possible to obtain multiple sets of acquired images corresponding to different experimental conditions such as different projection angles, different light source intensities, different camera sensitivities, etc. For example, a set of images a′, b′, c′, and d′ can be acquired for a first angle of projection, θ′ and after, a new set of images a″, b″, c″, and d″ can be obtained at a second projection angle, θ″. Or, instead of varying the angle of projection, the angle of detection can be varied by changing the camera inclinaison with respect to the projection axis. Or, the intensity of the source or the camera acquisition time can be varied. In all cases, for each of these two (or more) sets of acquired images, the phase can be calculated by using the following relations:

$$tg {φ}^{′} ( x , y ) = \frac{{I}_{d}^{′} ( x , y ) - {I}_{b}^{′} ( x , y )}{{I}_{a}^{′} ( x , y ) - {I}_{c}^{′} ( x , y )} \qquad ( 4 )$$

$$tg {φ}^{″} ( x , y ) = \frac{{I}_{d}^{″} ( x , y ) - {I}_{b}^{″} ( x , y )}{{I}_{a}^{″} ( x , y ) - {I}_{c}^{″} ( x , y )} \qquad ( 5 )$$

Then those two phase values, φ′(x,y) and φ″(x,y), are merged in order to formed a combined phase value, \tilde{φ}(x,y).

In both cases, (combined images or combined phases), a merge of multiple measurements is performed. In the first case, it is a fusion of I′(x,y), I″(x,y), . . . into a resulting composite image Ĩ(x,y). In the second case, it is a merge (or a fusion) of multiple phase values φ′(x,y), φ″(x,y) , . . . into a resulting phase \tilde{φ}(x,y). Such a data merge and fusion is achieved using a regularization algorithm, such as, for example, a Kalman regularization filter or simply by averaging the data. In the fusion or the averaging, a weight of each data (as a function of pixel variance, for example) is taken into account in order to improve the precision of final data.

In the case when all points are “valid” (see discussion hereinabove), the obtained φ′(x,y), φ″(x,y), have close values and the equations (3) and (4-5) yield similar results. The fusion of multiple phase (relations 4-5) or intensity values (relation 3) allows an increased precision and repeatability of the measurements.

If, for example, values I′(x,y) are very bright and close to saturation, it may be advantageous to use the relation (3) with combined images formed with intensities I″(x,y) acquired with a lower exposed time, so as to obtain a better evaluation of the phase value φ(x,y).

In an opposite case of a dark region, in order to evaluate the phase (and the 3D information), it may be more advantageous to use values with longer exposing time I″(x,y) to calculate the phase value.

Although the principles of the present invention have been described in relation with four phase-shifted images, it is also possible to choose a set of acquired images corresponding to different phase shifts from those presented in (1) that are appropriate to the specific inspection conditions. In such case, an appropriate phase calculation formula, corresponding to the chosen set of phase-shifts, should be used.

Persons skilled in the art will appreciate that the present invention allows an increase of the dynamic range of any 3D measurement system based on the phase-shift method, such as a FMI system for example. The present invention teaches a combination of a plurality of images acquired in different ways a person in the art may contemplate, for example with different intensities, or images taken with different cameras in different conditions, etc., to increase the sensitivity and dynamic range of 3D and 2D measurement systems. Therefore, the present invention makes possible 3D/2D inspection of object with bright/dark regions presence, like BGA/CSP microelectronic components for example.

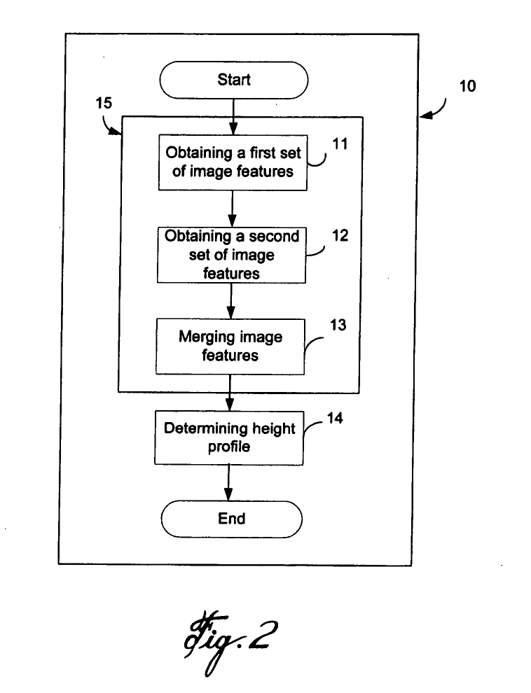

A method 10 in accordance with the present invention is described in FIG. 2. At step 11, a first set of image features are obtained. At step 12, a second set of image features are obtained. Then at step 13, a merging of the images features is performed. Then, using the results of step 13, the height profile of the object is determined.

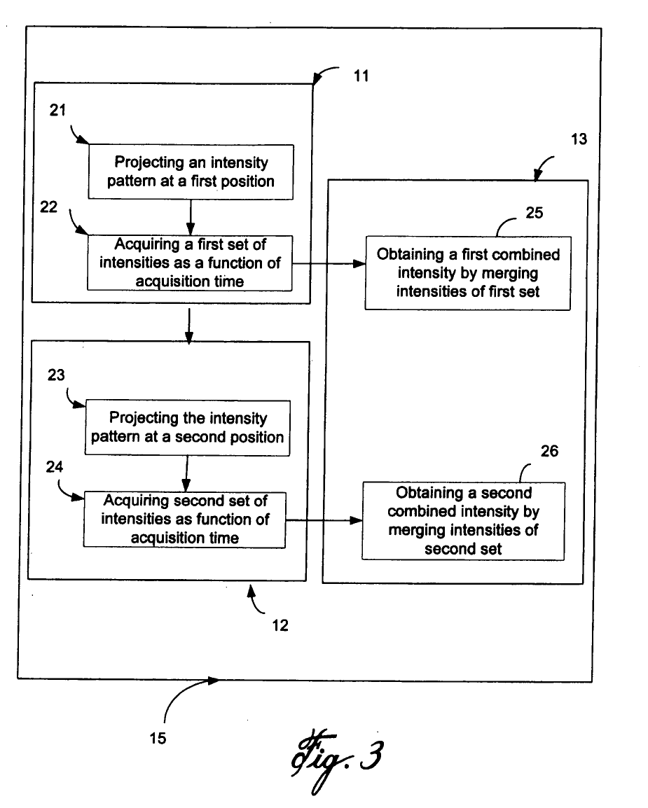

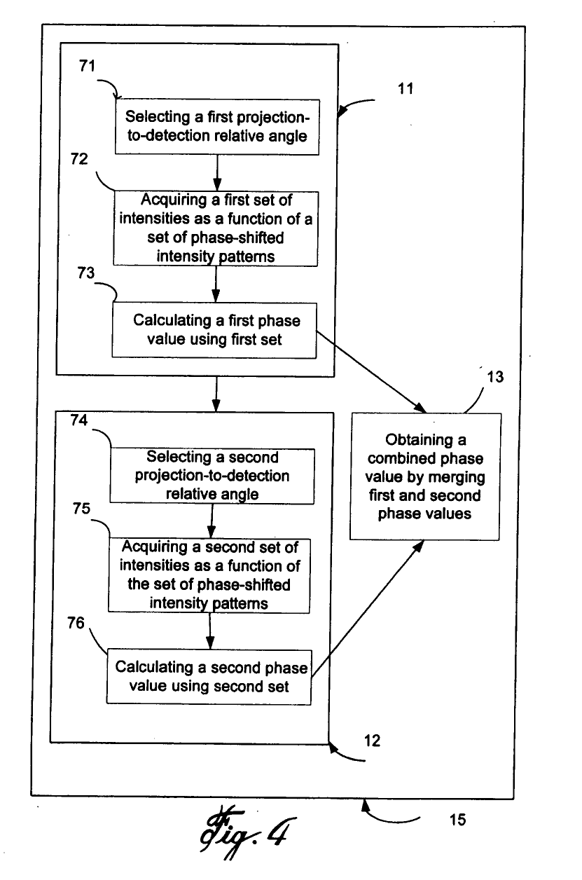

Details of steps 11, 12, and 13 are dependant on the type of merging that is performed and also on the acquiring conditions that are varied. When the method 10 is used to obtained a combined image by varying, for example, the acquisition time, then the details of steps 11, 12, and 13 are described by FIG. 3. When the method 10 is used to obtained a combined phase value by varying, for example, the projection-to-detection relative angle, then the details of steps 11, 12, and 13 are better described by FIG. 4. FIG. 3 and FIG. 4 correspond to two different experimental configurations, where, to improve the precision or the quality of the acquired data, different experimental conditions are varied. It is understood that although, in the following examples, we discuss the case where these variable experimental conditions are acquisition time and a projection-to-detection angle, other experimental conditions may as well be varied (such as for example varying the light source intensity, the magnification of the optical system, etc.), as it will be obvious for someone skilled in the art.

Also, as someone skilled in the art will know, other step sequences than those presented on FIG. 3 and FIG. 4 can be used to provide the results of the method 10. For instance, as it will be obvious for a person skilled in the art, once the intensities characterizing the object Iₐ′(x,y), Iₐ″(x,y), I_{b}′(X,Y), I_{b}″(x,y), have been acquired, then, either combined images, Ĩₐ(x,y) Ĩ_{b}(x,y), or a merged phase, \tilde{φ}(x,y), can be calculated from those intensities. In other words, in may be advantageous in some circumstances to determine several phase values and merged them to get a final phase value, or to combine intensities in order to get combined images to calculate a final phase value.

In FIG. 3, two combined images are obtained in step 13. First, at step 21, an intensity pattern is projected at a first position on the object. This experimental condition corresponds to a first acquiring condition. This is followed in step 22 by acquiring a first set of intensities, Iₐ′(x,y), Iₐ″(x,y), . . . , as a function of the acquisition time. These intensities, obtained at the first acquiring condition, constitute the first set of image features of step 11. Then, at step 23, the acquiring condition is changed by having the intensity pattern phase-shifted such that it is projected at a second position on the object. This is followed in step 24 by acquiring a second set of intensities, I_{b}′(x,y), I_{b}″(x,y), . . . , as a function of the acquisition time. Those intensities, obtained at the second acquiring condition, constitute the second set of image features of step 12. The first set of intensities are then merged to obtained a first combined intensity, Ĩₐ(x,y) (step 25), and the second set of intensities are merged to obtained a second combined intensity, Ĩ_{b}(x,y) (step 26). Thus as a result, two combined images are provided to determine the height profile of the object.

It is worthwhile to mention that although in this particular example, both acquiring conditions lead to combined intensities, this invention naturally includes the case where only one combined intensity (for example step 25) in the first acquiring condition is obtained, whereas, in the second acquiring condition, only one intensity is acquired (at step 24) such that the set comprises only one intensity.

In FIG. 4, a combined phase value is obtained in step 13. First, at step 71, a first projection-to-detection angle θ′ is selected. This experimental condition corresponds, in that case, to a first acquiring condition. Then, at step 72, a first set of intensities, Iₐ′(x,y), I_{b}′(x,y), . . . , is acquired as a function of a set (a,b, . . . ) of phase-shifted intensity patterns that is projected on the object. Then a first phase value φ′(x,y) is calculated using the first set of intensities (step 73). This first phase value, obtained at the first acquiring condition, constitutes the first set of image feature of step 11. Then, at step 74, the acquiring condition is changed to a second acquiring condition corresponding to a second projection-to-detection angle θ″. At step 75, a second set of intensities, Iₐ″(x,y), I_{b}″(x,y), . . . , are acquired as a function of the set (a,b, . . . ) of phase-shifted intensity patterns. Then a second phase value φ″(x,y) is calculated using the second set of intensities (step 76). This second phase value, obtained at the second acquiring condition, constitutes the second set of image feature of step 11. Finally, the combined phase value is obtained by merging φ′(x,y) and φ″(x,y) at step 13.

As another example, the steps of FIG. 4 can be implemented by having as a first acquiring condition, one acquisition time (or light source intensity) and, as a second acquiring condition, a second acquisition time (or light source intensity).

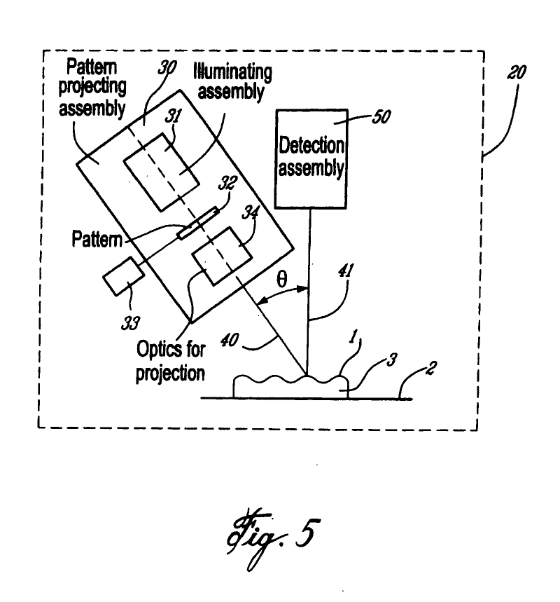

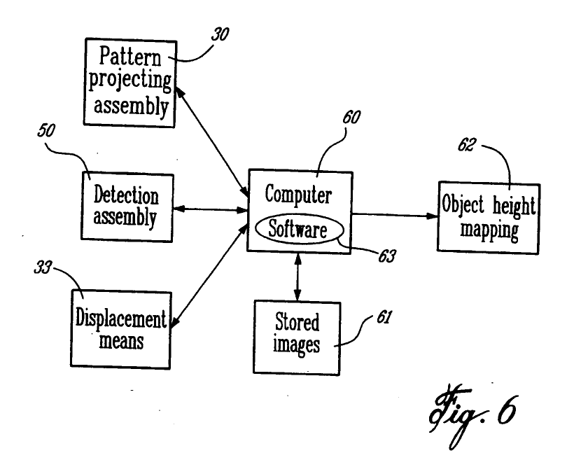

Turning now to FIGS. 5 and 6, a system 20 for determining a height profile of the object, according to an embodiment of the present invention, is shown. In FIG. 5, a pattern projection assembly 30 is used to project onto the surface 1 of the object 3 an intensity pattern having a given fringe contrast function M(x,y). A detection assembly 50 is used to acquire the intensity values that have been mathematically described by the equation set (1). The detection assembly 50 can comprise a CCD camera or any other detection device. The detection assembly 50 can also comprise the necessary optical components, known to those skilled in the art, to relay appropriately the projected intensity pattern on the object to the detection device. The pattern projection assembly 30 is projecting the intensity pattern at an angle θ with respect to the detection axis 41 of the detection assembly, where the angle θ is the so-called projection-to-detection relative angle. The pattern projection assembly can comprises, for example, an illuminating assembly 31, a pattern 32, and optics for projection 34. The pattern 32 is illuminated by the illuminating assembly 31 and projected onto the object 3 by means of the optics for projection 34. The pattern can be a grid having a selected pitch value, p. Persons skilled in the art will appreciate that other kinds of patterns may also be used. The characteristics of the intensity pattern can be adjusted by tuning both the illuminating assembly 31 and the optics for projection 34. The pattern displacement means 33 is used to shift, in a controlled manner, the pattern relatively to the object. The displacement can be provided by a mechanical device or could also be performed optically by translating the pattern intensity. This displacement can be controlled by a computer 60. Variants means for shifting the pattern relative to the object include displacement of the object 3 and displacement of the pattern projection assembly 30.

As illustrated in FIG. 6, computer 60 can also control the alignment and magnification power of the pattern projection assembly and the alignment of the detection assembly 50. Naturally, computer 60 is used to compute the object height profile from the data acquired by the detection assembly 50. Computer 60 is also used to store acquired images and corresponding phase values 61, and manage them. A software 63 can act as an interface between the computer and the user to add flexibility in the system operation.

One of the main feature of software 63 is to provide the algorithm to merge the acquired images features in steps 11 and 12, in order to obtain either the combined intensity or the combined phase. As mentioned earlier, this algorithm, in a preferred embodiment, is based on a Kalman algorithm where a weight is associated to each experimental pixel values, the weight corresponding to an estimation of the experimental error or the “validity” of the data. In another embodiment, the algorithm performed a weighted average of the data. Thus, with the software 63, a weight may be automatically associated to each data.

The above-described method 10 and system 20 can be used to map the height of an object with respect to a reference surface or to compute the relief of an object. The reference surface may be a real surface, the surface of a part of the object, or even a virtual surface. This results in a 3D measurement of the object.

It may also be used to measure a height profile corresponding to a virtual cross-section of the object. In that case a 2D measurement of the object is provided.

The above-described method 10 and system 20 can also be used for detecting defects on an object in comparison with a similar object used as a model or to detect changes of an object surface with time. In all cases, the above-described method 10 and system 20 can further include the selection of an appropriate intensity pattern and of an appropriate acquisition resolution that will be in accordance with the height of the object to be measured.

Although the present invention has been described hereinabove by way of embodiments thereof, it can be modified, without departing from the spirit and nature of the subject invention as defined herein.

What is claimed is:

1. An interferometric method for determining a height profile of an object, the method comprising:
at a first acquiring condition, obtaining at least two image features characterizing the object, each one of the image features being obtained at different gathering conditions, so as to provide a first set of at least two image features;
at a second acquiring condition, obtaining at least one image feature characterizing the object, so as to provide a second set of at least one image feature;
merging said image features for providing a merged image feature; and
determining said height profile using said merged image feature and a phase value associated to a surface.

2. The method as claimed in claim 1, wherein said height profile of said object comprises at least one of a relief of the object and a virtual cross-section of the object.

3. The method as claimed in claim 2, wherein said first acquiring condition comprises a projection of an intensity pattern on the object and wherein said second acquiring condition comprises a phase-shifted projection of said pattern on said object.

4. The method as claimed in claim 3, wherein said intensity pattern comprises a sinusoidal pattern.

5. The method as claimed in claim 4, wherein the different gathering conditions are different acquisition times and wherein said first set of at least two image features comprises two intensities characterizing said object, each one of the intensities being obtained with one of the different acquisition times.

6. The method as claimed in claim 5, wherein said intensities characterizing said object comprises visible light intensities.

7. The method as claimed in claim 5, wherein said merged image feature comprises a first and second combined intensities, wherein the first combined intensity is obtained using said first set of at least two image features and wherein the second combined intensity is obtained using said second set of at least one image feature.

8. The method as claimed in claim 7, further comprising associating to said image features weight features.

9. The method as claimed in claim 8, wherein said weight features represent an uncertainty of said image features.

10. The method as claimed in claim 9, wherein said combined intensities are obtained using a Kalman algorithm.

11. The method as claimed in claim 10, further comprising evaluating a volume of the object from said relief of said object.

12. The method as claimed in claim 2, wherein said first acquiring condition comprises at least one of a first projection-to-detection relative angle and first acquisition time, and wherein said second acquiring condition comprises at least one of a corresponding second projection-to-detection relative angle and second acquisition time.

13. The method as claimed in claim 12, wherein said first projection-to-detection angle is an angle between a first projection axis and a detection axis and wherein said second projection-to-detection angle is an angle between a second projection axis and said detection axis.

14. The method as claimed in claim 12, wherein the different gathering conditions are phase-shifted projections of an intensity pattern and wherein said first set of at least two image features comprises two intensities characterizing said object and a phase value, one intensity being obtained at a first projection of the intensity pattern on the object along said first projection axis, the second intensity being obtained with a phase-shifted projection of said intensity pattern on said object along said first projection axis, and the phase value being determined from the two intensities characterizing said object.

15. The method as claimed in claim 14, wherein said intensity pattern comprises a sinusoidal pattern.

16. The method as claimed in claim 15, wherein said intensities characterizing said object comprises visible light intensities.

17. The method as claimed in claim 16, wherein said merged image feature comprises a combined phase value obtained using said phase value from first set of image features and a second phase value obtained from said second set of image features.

18. The method as claimed in claim 17, further comprising associating to said image features weight features.

19. The method as claimed in claim 18, wherein said weight features represent an uncertainty of said image features.

20. The method as claimed in claim 19, wherein said combined phase value is obtained using a Kalman algorithm.

21. The method as claimed in claim 20, further comprising evaluating a volume of the object from said relief of said object.

22. The method as claimed in claim 2, further comprising associating to said image features weight features.

23. The method as claimed in claim 22, wherein said weight features represent an uncertainty of said image features.

24. The method as claimed in claim 23, wherein said at least one merged image feature is obtained by combining said image features using a Kalman algorithm.

25. The method as claimed in claim 1, wherein said merged image feature comprises a first and second combined intensities, wherein the first combined intensity is obtained using said first set of at least two image features and wherein the second combined intensity is obtained using said second set of at least one image feature.

26. The method as claimed in claim 25, wherein said first set of image features is obtained at a first projection of an intensity pattern on the object and said second set of images features is obtained with a phase-shifted projection of said intensity pattern on said object.

27. The method as claimed in claim 1, wherein said first set of at least two image features comprises two intensities characterizing said object and a phase value, one intensity being obtained at a first projection of an intensity pattern on the object, the second intensity being obtained with a phase-shifted projection of said intensity pattern on said object, and the phase value being determined from the two intensities characterizing said object.

28. An interferometric method for determining a height profile of an object, the method comprising:
at a first projection of an intensity pattern on the object, obtaining a first set of at least two intensities characterizing the object, each one of the intensities corresponding to a different gathering condition, and combining the intensities to obtain a first merged image;
at a phase-shifted projection of the intensity pattern on the object obtaining a second set of at least one intensity characterizing the object and combining the intensities of the second set to obtain a second merged image; and
determining said height profile using said first and second merged images and a phase value associated to a surface.

29. An interferometric method for determining a height profile of an object, the method comprising:
obtaining a first set of intensities characterizing the object under a first acquiring condition, each of said intensities characterizing the object corresponding to one of a series of projecting intensities on said object, each of said projecting intensities being phase-shifted from the others;
calculating a first phase value using said first set of intensities;
obtaining a second set of intensities characterizing the object under a second acquiring condition, each of said intensities of the second set corresponding to one of a second series of projecting intensities on said object, each of said projecting intensities of said second series being phase-shifted from the others;
calculating a second phase value using said second set of intensities;
merging said phase values for providing a merged phase value; and
determining said height profile using said merged phase value and a phase value associated to a surface.

30. An interferometric system for determining a height profile of an object, the system comprising:
a pattern projection assembly for projecting, onto the object, an intensity pattern along a projection axis;
displacement means for positioning, at selected positions, said intensity pattern relative to said object;
a detection assembly for obtaining, at a first acquiring condition, a first set of at least two image features, and obtaining, at a second acquiring condition, a second set of at least one image feature; and
a computer for calculating a merged feature using said images features and for determining the height profile of the object by using said merged feature and a reference phase value associated to the reference surface,
the interferometric system having at least one of the following characteristics: the detection assembly has a tunable acquisition time and the pattern projection assembly has a tunable intensity projection.

31. The system as claimed in claim 30, wherein said detection assembly comprises a detector with a tunable acquisition time.

32. The system as claimed in claim 30, wherein said pattern projection assembly comprises a light source with a tunable intensity.

33. The system as claimed in claim 30, further comprising a controller software to control one of at least the projection assembly, the detection assembly and the displacement means.

34. The system as claimed in claim 33, wherein said controller software comprises controlling said displacement means such that the first set of at least two images features is obtained at a first projection of the intensity pattern and the second set of at least one image feature is obtained at a second projection of the intensity pattern.

35. The system as claimed in claim 33, wherein said controller software comprises controlling said detector assembly such that the first set of at least two images features is obtained at a first acquisition time and the second set of at least one image feature is obtained at a second acquisition time.

36. The method as claimed in claim 1, further comprising evaluating a volume of the object from said relief of said object.

37. The method as claimed in claim 28, further comprising evaluating a volume of the object from said relief of said object.

38. The method as claimed in claim 29, further comprising evaluating a volume of the object from said relief of said object.
